(19) United States
(12) Patent Application Publication
(10) Pub. No.: US 2024/0097257 A1
(43) Pub. Date: Mar. 21, 2024

(54) BATTERY DEVICE FOR AN AT LEAST SEMI-ELECTRICALLY POWERED MOTOR VEHICLE, AND COMPRESSION PADS, AS WELL AS METHOD FOR MANUFACTURING

(71) Applicant: Dr. Ing. h.c. F. Porsche Aktiengesellschaft, Stuttgart (DE)

(72) Inventor: Dominik Grass, Bietigheim-Bissingen (DE)

(73) Assignee: Dr. Ing. h.c. F. Porsche Aktiengesellschaft, Stuttgart (DE)

(21) Appl. No.: 18/244,985

(22) Filed: Sep. 12, 2023

(30) Foreign Application Priority Data
Sep. 19, 2022 (DE) 10 2022 123 880.6

(51) Int. Cl. H01M 50/242; H01M 10/613; H01M 10/6568; H01M 50/238

(52) U.S. Cl. CPC H01M 50/242; H01M 10/613; H01M 10/6568; H01M 50/238

(57) ABSTRACT

Battery device for an at least semi-electrically powered motor vehicle includes a battery housing and an assembly of battery cells and compression pads arranged between the battery cells. The compression pads are elastically configured in order to be able to exert a surface compression on the battery cells and to compensate for volume changes of the battery cells. The compression pads each include at least one swelling body, which is suitable and configured to expand from an unswollen pre-mounting state to a swollen finished mounting state by absorbing an activator fluid, thereby increasing its volume such that the compression pads can exert their intended surface compression on the battery cells.

### CROSS-REFERENCE TO RELATED APPLICATION

This application claims priority to German Patent Application No. 10 2022 123 880.6, filed Sep. 19, 2022, the content of such application being incorporated by reference herein in its entirety.

### FIELD OF THE INVENTION

The present invention relates to a battery device for a motor vehicle with at least one battery housing and with at least one assembly of battery cells and with compression pads arranged between the battery cells. The compression pads are at least partially elastically configured in order to be able to exert surface compression on the battery cells and to compensate for volume changes of the battery cells.

### BACKGROUND OF THE INVENTION

In such battery devices, in operation, the battery cells are typically subjected to targeted surface compression or pressure so that they function well and are long-lasting. To ensure the surface compression on the battery cells, the elastic compression pads are installed between the battery cells. For example, a battery device with compression pads is known from DE 10 2018 214 528A1, which is incorporated by reference herein.

In and of themselves, such battery devices function well and reliably overall. However, the battery cells need to be stacked together with the compression pads in order to form a sandwich-like mounting assembly as part of the manufacturing of the battery device. The compression pads must then be purposefully compressed or pressed down so that the mounting assembly can be inserted into the battery housing module housing. This is a very complex and difficult assembly step.

An apparatus is often used in order to grip and compress the mounting assembly in order to enable insertion under pressure. However, it is very tedious to remove the apparatus from the battery housing after insertion. Thus, the apparatus often remains in the battery housing and requires additional design space and increases the weight.

By contrast, described herein is an improved and in particular inexpensive and simultaneously reliable option for manufacturing a battery device.

### SUMMARY OF THE INVENTION

The battery device according to aspects of the invention is provided for an at least semi-electrically driven motor vehicle. The battery device comprises at least one battery housing and at least one assembly of battery cells and compression pads arranged between the battery cells. The compression pads are at least partially elastically configured, in particular in order to be able to exert a surface compression on the battery cells and/or compensate for volume changes of the battery cells. The compression pads at least partially comprise at least one swelling body each. The swelling body is suitable and configured so as to expand (in particular after an assembly of the compression pad in its intended mounting position in the battery housing) from an unswollen (in particular dry), pre-mounting state into a swollen, finished mounting state by absorbing an activator fluid. The swelling body is particularly suitable and configured so as to increase its volume by expanding such that the compression pads (due to the swelling of the swelling bodies) can exert their intended surface compression on the battery cells.

The battery device according to aspects of the invention offers many advantages. A significant advantage is provided by the compression pads with their swelling bodies. This makes the compression pads and the entire mounting assembly particularly compact and easy to handle during installation. This significantly simplifies insertion into the battery housing. Measures to compress or press down the compression pads can be omitted. In addition, an apparatus that would remain in the battery housing after installation and thereby increase the weight and consume design space can be omitted. With the invention, this design space is available for battery cells, for example, so that the battery device can be equipped with a larger number of battery cells for the same design space need. At the same time, the invention provides a reliable compensation for the volume change of the battery cells in operation.

In a particularly advantageous and preferred configuration, the battery device comprises at least one cooling device for direct cooling of battery cells. In particular, a coolant can directly flow around at least sections of the battery cells and the compression pads. The activator liquid is preferably the coolant. This can further simplify assembly, because the activator fluid is provided by the already given coolant. For example, the swelling bodies are transferred to the finished mounting state in that the coolant is introduced into the battery housing during the manufacture of the cooling device.

In particular, the swelling bodies absorb the activator fluid and preferably the coolant and thus swell up so that the compression pads can exert their intended surface compression on the battery cell. In particular, the battery cells and the compression pads are surrounded (in a floating manner) by the coolant in the battery housing. The coolant is in particular used in order to temperature-control the battery cell in normal operation by means of heat dissipation (cooling) or heat supply (heating). In the context of the present invention, the term cooling is preferably understood to mean a temperature-control which can include both a cooling and a heating.

It is preferred and advantageous that the swelling body comprises or consists of a sponge-like material. In particular, the sponge-like material is elastically formed.

It is possible and advantageous that the battery cells and the compression pads are (or will be) stacked into at least one mounting assembly. The mounting assembly is smaller than a mounting space provided for the mounting assembly in the battery housing. This is particularly the case when the swelling bodies are in the unswollen pre-mounting state. It is thus in particular achieved that the mounting assembly can be mounted without touching or abutment and can in particular be inserted into the battery housing without pressing. In particular, the mounting assembly is larger than a design space provided for it in the battery housing when the swelling bodies are in the swollen finished mounting state (and the provided surface compression is provided on the battery cells).

Preferably, the swelling body provides the elastic properties of the (associated) compression pad at least partially, and in particular in a majority, and preferably (substantially) completely. In particular, the swelling body provides those elastic properties of the compression pad that are necessary to exert an intended surface compression on the battery cells and/or to compensate for volume changes of the battery cells.

The compression pad according to aspects of the invention serves for use in the battery device described here. The compression pad according to aspects of the invention also solves the previously posed problem particularly advantageously. In particular, the compression pad is configured as disclosed in the description of the battery device according to aspects of the invention.

The method according to aspects of the invention serves for the production of a battery device with at least one battery housing and at least one assembly of battery cells and compression pads arranged between the battery cells. The battery cells and the compression pads comprising at least one swelling body are stacked into a mounting assembly. The mounting assembly is inserted into a battery housing. The swelling bodies are thereby in an unswollen pre-mounting state. Subsequently, an activator liquid is introduced into the battery housing. The swelling bodies at least partially absorb the activator liquid and thereby expand into a swollen, finished mounting state. In particular, the swelling bodies thereby exert their intended surface compression on the battery cells.

In particular, the compression pads are configured as disclosed in the description of the battery device according to aspects of the invention. In particular, the method serves to produce the battery device according to aspects of the invention and preferably also its configurations. In particular, the method is configured so that the battery device according to aspects of the invention can be produced. In particular, the battery device according to aspects of the invention is suitable and configured so as to be produced according to the method according to aspects of the invention. For this purpose, the features formulated in a method-like manner here can in particular be read as apparatus features.

In particular, the mounting assembly is enlarged following the introduction of the activator liquid due to the expansion of the swelling bodies arranged therein. Prior to the insertion of the activator liquid, the mounting assembly is in particular introduced into a design space provided for it in the battery housing without compressing it (with a force corresponding to the surface pressure or any force at all). Preferably, the mounting assembly is inserted into the battery housing without compression. In one configuration in which a (slight) compression of the mounting assembly takes place, the force provided is many times less than the force for the intended surface compression.

Preferably, a liquid coolant (for a cooling device for direct cooling of the battery cells) is introduced into the battery housing. In particular, the swelling bodies at least partially absorb the coolant. In particular, the swelling bodies thereby expand into the swollen finished mounting state. In particular, the introduction of the coolant takes place as part of the production of the cooling device. In particular, there thus occurs an initial contact of the swelling bodies with the coolant.

In particular, a stroke that the compression pads each perform in order to compensate for the operational volume changes of the battery cells is less than a stroke that the compression pads each perform due to the transition from the pre-mounting state into the finished mounting state (through the swelling of the swelling bodies). In other words, the stroke due to the swelling of the swelling bodies is in particular larger and preferably at least two times larger than the stroke in order to equalize the volume changes of the battery cells.

### BRIEF DESCRIPTION OF THE DRAWINGS

Further advantages and features of the present invention follow from the embodiment examples, which are described below with reference to the accompanying drawings.

The drawings show:

FIG. 1 a purely schematic illustration of a battery device according to aspects of the invention during its manufacture in a sectioned side view;

FIG. 2 the battery device of FIG. 1 during a further step of its manufacture in a sectioned side view; and

FIG. 3 a detail representation of a further battery device according to aspects of the invention in a perspective view.

### DETAILED DESCRIPTION OF THE INVENTION

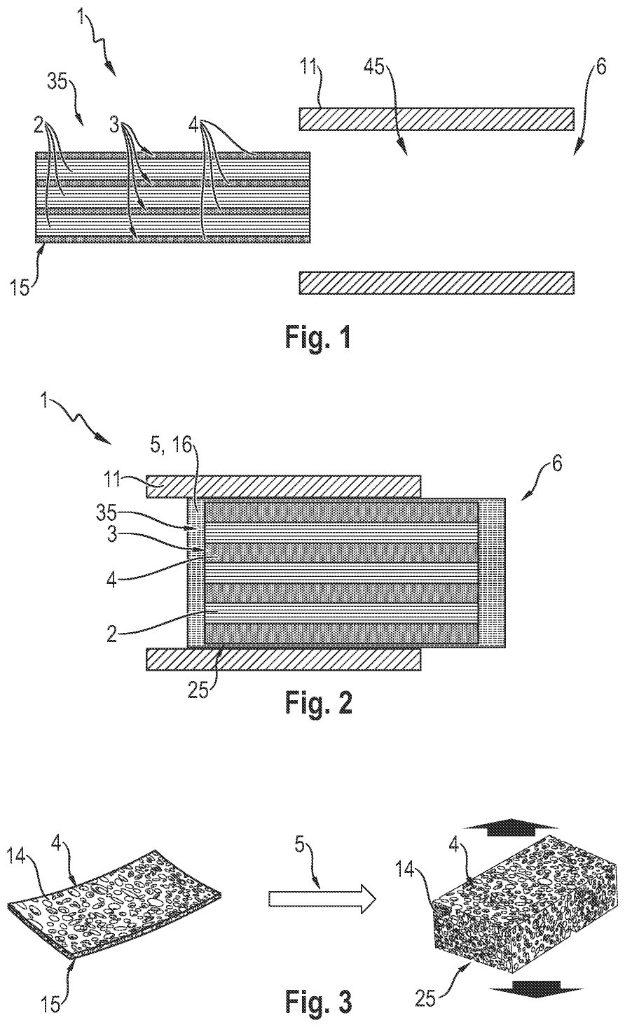

FIGS. 1 and 2 show a battery device 1 according to aspects of the invention during its manufacture. The battery device 1 comprises an assembly of battery cells 2 and compression pads 3 arranged between the battery cells 2. The battery cells 2 and the compression pads 3 are accommodated in a battery housing 11 shown only in part here for ease of reference. The compression pads 3 are elastic and are designed so as to compensate for operational volume changes of the battery cells 2 and provide a targeted surface compression on the battery cells 2. The force curve acting for the surface compression is outlined in FIG. 2 by block arrows.

A cooling device 6 serves for a direct cooling of the battery cells 2 by means of a liquid coolant 16. For example, the coolant 16 flows into the housing 11 via an inlet (not shown), and there along the battery cells 2 and compression pads 3. The cooling medium can leave the housing 11 again via a drain (not shown).

In the following, with reference to FIGS. 1 and 2, an exemplary procedure of the method according to aspects of the invention as well as the battery device 1 are described.

The compression pads 3 each comprise an elastic swelling body 4, which consists of a foam-like material 14, for example. The battery cells 2 and the compression pads 3 with their swelling bodies 4 are stacked in a sandwich-like manner so that the mounting assembly 35 shown here results.

The swelling bodies 4 can expand from an unswollen pre-mounting state 15 (see FIG. 1) into a swollen finished mounting state 25 (see FIG. 2) by absorbing an activator fluid 5. In the pre-mounting state 15, the mounting assembly 35 is significantly smaller or flatter than the design space 45 provided for it in the battery housing 11. As a result, the mounting assembly 35 can be easily inserted into the battery housing 11, e.g. without abutment. It does not need to be compressed or inserted into a compression apparatus.

This way, a significantly simpler and more cost-efficient mounting is possible. In addition, the apparatus that would otherwise have to remain in the battery housing 11 after installation and that would significantly restrict the design space 45 can be omitted. Design space 45 and weight can thereby be saved.

The battery housing 11 is then flooded with the coolant 16, whereby the swelling bodies 4 swell and expand into the finished mounting state 25. The coolant 16 thus serves as the activator fluid 5. The swelling bodies 4 fully fill with the coolant 16 by suction.

By the swelling of the swelling bodies 4, the compression pads 3 exert their intended surface compression onto the battery cells 2. Without the limiting effect of the battery housing 11, the mounting assembly 35 in the finished mounting state 25 would be much larger than the design space 45 provided for it. The stroke of the swelling bodies 4 between the pre-mounting state 15 and the finished mounting state 25 is, for example, at least twice its strength in the pre-mounting state 15.

The absorption of the coolant 16 increases the volume of the swelling bodies 4 and thus also the compression pad 3, such that these components increase the surface compression or compressive force on the battery cells 2. After swelling, the compression pads 3 and the swelling bodies 4 remain elastic in order to be able to compensate for the volume change and the swelling of the battery cells 2, respectively.

FIG. 3 shows a swelling body 4 in a pre-mounting state 15 (left) and in a finished mounting state 25 (right). By contact with the activator liquid 5 (outlined by a block arrow), the swelling body 4 swells and increases its volume. By increasing the volume, the desired surface compression (outlined by block arrows) can be adjusted. Here, the swelling body 4 is made of a foam-like material 14, for example.

### LIST OF REFERENCE NUMBERS

1 Battery device
2 Battery cell
3 Compression pads
4 Swelling body
5 Activator liquid
6 Cooling device
11 Battery housing
14 Material
15 Pre-mounting state
16 Coolant
25 Pre-mounting state
35 Mounting assembly
45 Design space

What is claimed is:

1. A battery device for an at least semi-electrically powered motor vehicle, said battery device comprising:
at least one battery housing,
at least one assembly of battery cells arranged in the battery housing,
compression pads arranged between the battery cells, wherein the compression pads are at least semi-elastic in order to exert a surface compression on the battery cells and/or to compensate for volume changes of the battery cells,
wherein the compression pads at least partially comprise at least one swelling body, and the swelling body is configured to expand by absorption of an activator liquid from an unswollen pre-mounting state into a swollen finished mounting state and thereby increase in volume such that the compression pads can exert surface compression on the battery cells.

2. The battery device according to claim 1, further comprising at least one cooling device for directly cooling the battery cells, and in which a liquid coolant can flow directly around the battery cells and the compression pads at least in sections, wherein the activator liquid is the coolant.

3. The battery device according to claim 1, wherein the swelling body comprises a spongy material.

4. The battery device according to claim 1, wherein the battery cells and the compression pads are stacked to form at least one mounting assembly, and wherein the mounting assembly is smaller than a design space provided for the mounting assembly in the battery housing when the swelling bodies are in the unswollen pre-mounting state such that the mounting assembly is capable of being inserted into the battery housing without abutment.

5. The battery device according to claim 1, wherein the swelling body at least partially provides the elastic properties of the compression pad.

6. A compression pad for use with the battery device according to claim 1.

7. A motor vehicle comprising the battery device of claim 1.

8. A method for producing a battery device for an at least semi-electrically powered motor vehicle, said battery device comprising at least one battery housing, at least one assembly of battery cells, compression pads arranged between the battery cells, wherein the compression pads are at least semi-elastic in order to exert a surface compression on the battery cells and/or to compensate for volume changes of the battery cells, and wherein the compression pads each at least partially comprise at least one swelling body, wherein said method comprises:
stacking the battery cells and the compression pads to form a mounting assembly,
inserting the mounting assembly into a battery housing when the swelling bodies are in an unswollen pre-mounting state, and
introducing an activator liquid into the battery housing, which causes the swelling bodies to at least partially absorb the activator liquid and thereby expand into a swollen finished mounting state, such that the compression pads exert surface compression on the battery cells.

9. The method according to claim 8, further comprising introducing a liquid coolant for a cooling device into the battery housing for direct cooling of the battery cells, and wherein the swelling bodies at least partially absorb the coolant and thereby expand into the swollen finished mounting state.
